(19) United States
(12) Patent Application Publication
(10) Pub. No.: US 2015/0127641 A1
(43) Pub. Date: May 7, 2015

(54) METHOD AND SYSTEM FOR SEARCHING ON MOBILE TERMINAL

(71) Applicant: TENCENT TECHNOLOGY (SHENZHEN) COMPANY LIMITED, Shenzhen (CN)

(72) Inventor: XINGHUI QUAN, Shenzhen (CN)

(73) Assignee: TENCENT TECHNOLOGY (SHENZHEN) COMPANY LIMITED

(21) Appl. No.: 14/596,352

(22) Filed: Jan. 14, 2015

Related U.S. Application Data
(63) Continuation of application No. PCT/CN2013/079329, filed on Jul. 12, 2013.

(30) Foreign Application Priority Data
Jul. 18, 2012 (CN) 2012-10249199.2

(51) Int. Cl. G06F 17/30; H04W 8/18

(52) U.S. Cl. CPC G06F 17/30867; H04W 8/183; H04W 88/02
USPC 707/723; 707/722

(57) ABSTRACT

Methods and systems for searching on a mobile terminal are provided herein. In an exemplary method, a matching box can be provided on the mobile terminal in response to a click on a search box on the mobile terminal. An operation of a user can be determined. The operation of the user can include selecting a matching item from the matching box or inputting a keyword in the search box. The selected matching item can be used as a keyword to search on the mobile terminal when the user selects the matching item from the matching box. Alternatively, the inputted keyword in the search box can be used to search on the mobile terminal.

### CROSS-REFERENCES TO RELATED APPLICATIONS

This application is a continuation of PCT Application No. PCT/CN2013/079329, filed on Jul. 12, 2013, which claims priority to Chinese Patent Application No. 2012102491992, filed on Jul. 18, 2012, the entire contents of all of which are incorporated herein by reference.

### FIELD OF THE INVENTION

The present disclosure generally relates to searching technologies and, more particularly, relates to methods and systems for searching on a mobile terminal.

### BACKGROUND

With development of the Internet and 3G technology, more users are using mobile phones to get on the Internet. The users may access the network anytime anywhere via mobile phones, providing significant convenience. Compared with personal computers (PCs), however, mobile phones may not allow a fast input and may have limited intelligence and limited network data. When the users search on a mobile phone, keywords must be manually and/or completely inputted to perform a precise search. Such operation is cumbersome and time-consuming when using the phone keypad, affecting user experience.

Existing technologies include a matching method for a keyword searching by listing records of history, bookmarks, hot words, and other related contents. However, this does not use the user-entered-keywords to match contents that the user wants to search and does not simplify the user's inputting operations.

It is therefore desirable to provide methods and systems for searching on a mobile terminal with simplified inputting operations.

### BRIEF SUMMARY OF THE DISCLOSURE

According to various embodiments, there is provided a method for searching on a mobile terminal. A matching box can be provided on the mobile terminal in response to a click on a search box on the mobile terminal. An operation of a user can be determined. The operation of the user can include selecting a matching item from the matching box or inputting a keyword in the search box. The selected matching item can be used as a keyword to search on the mobile terminal when the user selects the matching item from the matching box. Alternatively, the inputted keyword in the search box can be used to search on the mobile terminal.

According to various embodiments, there is also provided a system for searching on a mobile terminal. The system can include a search-box clicking module, a keyword inputting module, and an operation determining module. The search-box clicking module can be configured to provide a matching box on the mobile terminal by clicking on a search box on the mobile terminal. The operation determining module can be configured to determine an operation of a user. The operation of the user can include selecting a matching item from the matching box or inputting a keyword in the search box. The selected matching item can be used as a keyword to search on the mobile terminal when the user selects the matching item from the matching box. The keyword inputting module can be configured for the user to input the keyword in the search box for searching by the inputted keyword.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts an exemplary method for searching on a mobile terminal in accordance with various disclosed embodiments;

FIG. 2 depicts another exemplary method for searching on a mobile terminal in accordance with various disclosed embodiments;

FIG. 3 depicts an exemplary system for searching on a mobile terminal in accordance with various disclosed embodiments;

FIG. 4 depicts another exemplary system for searching on a mobile terminal in accordance with various disclosed embodiments;

FIG. 5 depicts an exemplary environment incorporating certain disclosed embodiments; and

FIG. 6 depicts an exemplary server consistent with the disclosed embodiments.

### DETAILED DESCRIPTION

Reference will now be made in detail to exemplary embodiments of the invention, which are illustrated in the accompanying drawings.

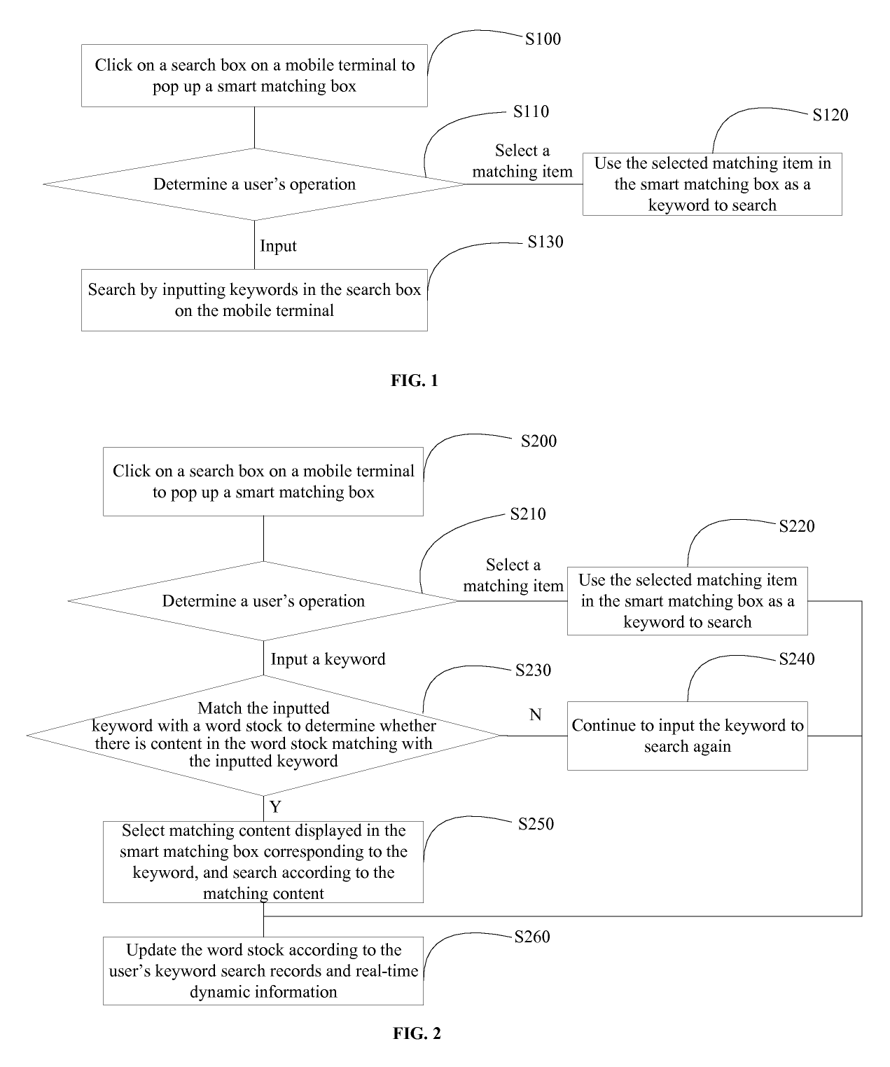

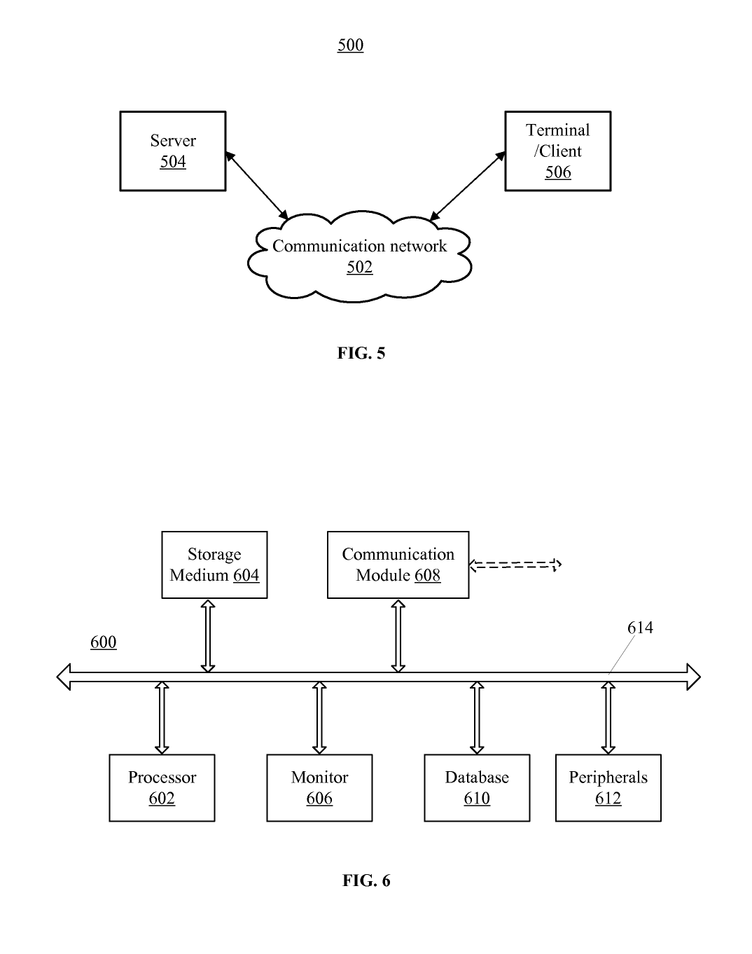

FIGS. 1-4 depict exemplary methods and systems for searching on a mobile terminal in accordance with various disclosed embodiments. The exemplary methods and systems can be implemented, for example, in an exemplary environment 500 as shown in FIG. 5.

As shown in FIG. 5, the environment 500 can include a server 504, a terminal 506, and a communication network 502. The server 504 and the terminal 506 may be coupled through the communication network 502 for information exchange, such as Internet searching, webpage browsing, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless.

A terminal, as used herein, may refer to any appropriate user terminal with certain computing capabilities, such as a personal computer (PC), a work station computer, a server computer, a hand-held computing device (tablet), a mobile terminal (a mobile phone or a smart phone), or any other user-side computing device.

A server, as used herein, may refer one or more server computers configured to provide certain server functionalities, such as search engines and database management. A server may also include one or more processors to execute computer programs in parallel.

The server 504 and the terminal 506 may be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, a storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, such as ROM, RAM, and flash memory modules, and mass storages, such as CD-ROM, U-disk, removable hard disk, etc. The storage medium 604 may store computer programs for implementing various processes, when executed by the processor 602.

Further, the peripherals 612 may include I/O devices such as keyboard and mouse, and the communication module 608 may include network devices for establishing connections through the communication network 502. The database 610 may include one or more databases for storing certain data and for performing certain operations on the stored data, such as webpage browsing, database searching, etc.

In operation, the terminal 506 may cause the server 504 to perform certain actions, such as an Internet search or other database operations. The server 504 may be configured to provide structures and functions for such actions and operations. More particularly, the server 504 may include a data searching system for real-time database searching.

In various embodiments, a terminal such as a mobile terminal involved in the disclosed methods and systems can include the terminal 506, while a server involved in the disclosed methods and systems can include the server 504.

Referring to FIG. 1, in Step S100, a smart matching box can be popped up on the mobile terminal by clicking on a search box on a mobile terminal. In some embodiments, the term smart matching box can be interchangeably used with the term matching box.

The smart matching box can display matching contents/items including, for example, bookmarks, mostly visited records, search records (e.g., records of a search history), latest hot words, search lists (e.g., a ranking list based on the searched contents), and/or other matching items.

The mostly visited records can include, for example, common activities in daily life. Such common activities can include, e.g., train schedules, air ticket related information, weather conditions, etc. The mostly visited records can be stored locally on a mobile terminal and/or stored on a server.

The latest hot words can include real-time dynamic information (e.g., developments of news and activities) and/or network hot words (e.g., Gaddafi, Turkey earthquake, or “geili”) that are associated with a keyword inputted by a user. The latest hot words can be periodically updated to the local mobile terminal via a server, according to an update cycle of the real-time dynamic information.

The search records and/or the search list can include a ranking list of keywords searched by users through browsers, and counted by the server. The search records and the search list can include contents including, for example, that lean meat powder spreads without restriction in Shandong; Steve Jobs, etc.

Contents in the search records and/or the search list can be stored in word stock(s) after the search list from the search box of the browsers is counted by the server. According to changes of the search list, the word stock(s) can be regularly updated. When the user uses search engines to search by a keyword, contents related to the keyword can be directly matched from the word stock(s) with no need to request the server, each time when the character string changes. This can simplify the inputting operation for the searching and improve a response speed while saving the network traffic.

In Step S110, determine a user's operation is determined. The operation of the user can include, for example, selecting a matching item from the (smart) matching box or inputting a keyword in the search box on the mobile terminal. As disclosed herein, if the user selects the matching item from the smart matching box, the method proceeds to perform Step S120. If the user inputs a keyword in the search box, the method then proceeds to perform Step S130.

In Step S120, the selected matching item in the smart matching box is used as a keyword for the searching. The user can perform the searching by touching a screen of the mobile terminal (e.g., a phone) or by pressing the arrow keys to select and click on the matching item. There is no need to again manually inputting any word(s) on the phone screen. This can help the users more quickly find the searching results and more conveniently know the real-time dynamic information. In Step S130, search by inputting keyword(s) in the search box on the mobile terminal.

FIG. 2 depicts another exemplary method for searching on a mobile terminal in accordance with various disclosed embodiments.

In Step S200, a search box on a mobile terminal is clicked on to pop up a smart matching box. In other words, a matching box can be provided on the mobile terminal in response to a click on the search box on the mobile terminal.

The smart matching box can display matching contents including, for example, bookmarks, mostly visited records, search records (e.g., records of a search history), latest hot words, search lists (e.g., a ranking list based on the searched contents), and/or other matching items.

The mostly visited records can include, for example, information related to common activities in daily life. Such information can include, e.g., train schedules, air ticket related information, weather conditions, etc. The mostly visited records can be stored locally on a mobile terminal and/or stored on a server.

The latest hot words can include real-time dynamic information (e.g., dynamic developments of news, activities, etc.) and/or network hot words (e.g., Gaddafi, Turkey earthquake, or “geili”), that are associated with a keyword inputted by a user. The latest hot words can be periodically updated to the local mobile terminal via a server, e.g., according to an update cycle of the real-time dynamic information.

The search records and/or the search list can include a ranking list of keywords searched by users through browsers and counted by the server. The search records and the search list can include contents including, for example, that lean meat powder spreads without restriction in Shandong province, Steve Jobs, etc.

Contents in the search records and/or the search list can be stored in word stock(s) after the search list from the search box of the browsers is counted by the server. According to changes of the search list, the word stock(s) can be regularly updated. When the user uses search engines to search by a keyword, contents related to the keyword can be directly matched from the word stock(s) with no need to request the server when, each time, the character string changes. This can simplify the inputting operation for the searching and improve a response speed while saving the network traffic.

In Step S210, a user's operation is determined. If the user selects a matching item from the smart matching box, the method proceeds to perform Step S220. If the user inputs a keyword in the search box, the method proceeds to perform Step S230. In an exemplary embodiment, in Step S210, the user can exit the inputting focus from the search box to end current search.

In Step S220, the selected matching item in the smart matching box is used as a keyword for the searching and then the method proceeds to perform Step S260. As in Step S220, the user can perform the searching by touching a phone screen or by pressing arrow keys to select and click on the matching item. There is no need to again manually inputting words on the phone screen. This can help the users more quickly find the searching results and more conveniently know the real-time dynamic information.

In Step S230, the inputted keyword is matched with the matching items in the word stock(s) to determine whether there are contents in the word stock(s) matching with the inputted keyword. If there are no contents in the word stock(s) matching with the inputted keyword, the method proceeds to perform Step S240. If there are contents in the word stock(s) matching with the inputted keyword, the method proceeds to perform Step S250.

The word stock(s) can include, for example, a word stock of commonly used words, a word stock of search lists, and/or a word stock of real-time dynamic information related to the keyword.

The word stock of commonly used words can include, for example, train schedules, air ticket related information, and/or weather, etc. The word stock of search lists can include, for example, that lean meat powder spreads without restriction in Shandong province; Steve Jobs; etc. The word stock of real-time dynamic information related to the keyword can include, for example, Gaddafi, Turkey earthquake, etc.

The word stock of commonly used words can be stored locally on a mobile terminal or on a server. The word stock of search lists and the word stock of real-time dynamic information can be updated, via a server, according to the search lists searched in the search box of browsers by the users, to achieve “known you” (e.g., “you” as a “user”) to predict information for the keyword that the user inputted.

It should be noted that each word stock (e.g., the word stock of commonly used words, the word stock of search lists, and/or the word stock of real-time dynamic information) can include words in any one type of language in the world or in a mixed language form having two or more types of language. Of course, the user may input words on the mobile terminal including words in one certain type of language or including words in two or more different types of language.

For example, a user may enter a word “ [symbol] ” (meaning “fire”) in Chinese, the word “ [symbol] ” in Chinese can be respectively matched in the exemplary word stocks (e.g., the word stock of commonly used words, the word stock of search lists, and/or the word stock of real-time dynamic information). According to a search priority, words such as “ [symbol] ” (meaning “train schedules”, “ [symbol] ” (meaning “Naruto”), “ [symbol] ” (meaning “breaking out of fire”) etc., can be displayed on the smart matching box. In another example, a user may enter a word “ [symbol] ” (meaning “kindnes”) in Chinese. As a result, the smart matching box may display “ [symbol] ” (meaning “German”), “ [symbol] ” (meaning “Debon logistics”), “ [symbol] ” (meaning “Bundesliga”), etc. A user can search according to their search needs to select matching contents/items. This can simplify user's input operation.

One of ordinary skill in the art would appreciate that although words in Chinese are used herein as examples to implement the disclosed methods, other words in different type(s) of language may also be used and encompassed herein. For example, a user may enter a word “table” to be matched in the word stocks. As a result, the smart matching box may display, for example, “folding table”, “table definition”, “periodic table”, “vegetable”, etc. for the user to select therefrom to obtain desired matching contents/items.

In Step S240, the keyword continues to be inputted as needed for the searching and the method then proceeds to perform Step S260. In Step S240, if the word stocks do not include keyword matching contents (i.e., matching contents/items that match with the keyword inputted by the user), the keyword for searching can continue to be inputted to search again, e.g., via the server. Meanwhile, the server can update current search records in the word stocks to provide convenience for the user's next search or for other users to use. In this manner, searching on the mobile terminal can be more quickly and easily with improved searching frequency.

In Step S250, matching content displayed on the smart matching box corresponding to the keyword is selected to perform the searching according to the matching content.

In an exemplary embodiment, the word stock(s) can be classified to include various matching items. The matching items can include: bookmarks, mostly visited records, latest hot words, search records, search list, etc. In addition, the matching items can be set with various priority levels.

In Step S260, the server (or the mobile terminal) updates the word stock(s) according to the user's keyword search records and the real-time dynamic information. As the search volume increases, keywords searched via the mobile terminals increases. The server can update the word stock(s) with more comprehensive and accurate contents/items. The word stock(s) can be maintained up to date. In an exemplary embodiment, the word stocks can be periodically updated, e.g., having an update cycle of about 2 hours, 8 hours, 12 hours or any hours as desired. The update cycle can be dynamically adjusted according to the user's needs.

FIG. 3 depicts an exemplary system for searching on a mobile terminal in accordance with various disclosed embodiments. The exemplary system can include a search-box clicking module, a keyword inputting module, and/or an operation determining module.

The search-box clicking module is configured to click on a search box on a mobile terminal to pop up a smart matching box. The (smart) matching box can display matching contents including, for example, bookmarks, mostly visited records, search records (e.g., records of a search history), latest hot words, search lists (e.g., a ranking list based on the searched contents), and/or other matching items.

The mostly visited records can include, for example, common activities in daily life. Such common activities can include, e.g., train schedules, air ticket related information, weather conditions, etc. The mostly visited records can be stored locally on a mobile terminal and/or stored on a server.

The latest hot words can include real-time dynamic information (e.g., developments of news and activities) and/or network hot words (e.g., Gaddafi, Turkey earthquake, or “geili”) that are associated with a keyword inputted by a user. The latest hot words can be periodically updated to the local mobile terminal via a server, according to an update cycle of the real-time dynamic information.

The search records and/or the search list can include a ranking list of keywords searched by users through browsers, and counted by the server. The search records and the search list can include contents including, for example, that lean meat powder spreads without restriction in Shandong; Steve Jobs, etc.

Contents in the search records and/or the search list can be stored in word stock(s) after the search list from the search box of the browsers is counted by the server. According to changes of the search list, the word stock(s) can be regularly updated. When the user uses search engines to search by a keyword, contents related to the keyword can be directly matched from the word stock(s) with no need to request the server, each time when the character string changes. This can simplify the inputting operation for the searching and improve a response speed while saving the network traffic.

The keyword inputting module is configured to input keyword(s) in the search box on the mobile terminal. The operation determining module is configured to determine a user's operation. In some embodiments, if the user selects a matching item from the smart matching box, the selected matching item can be used as a keyword for the searching. In other embodiments, if the user inputs a keyword in the search box, the keyword can be inputted by the keyword inputting module.

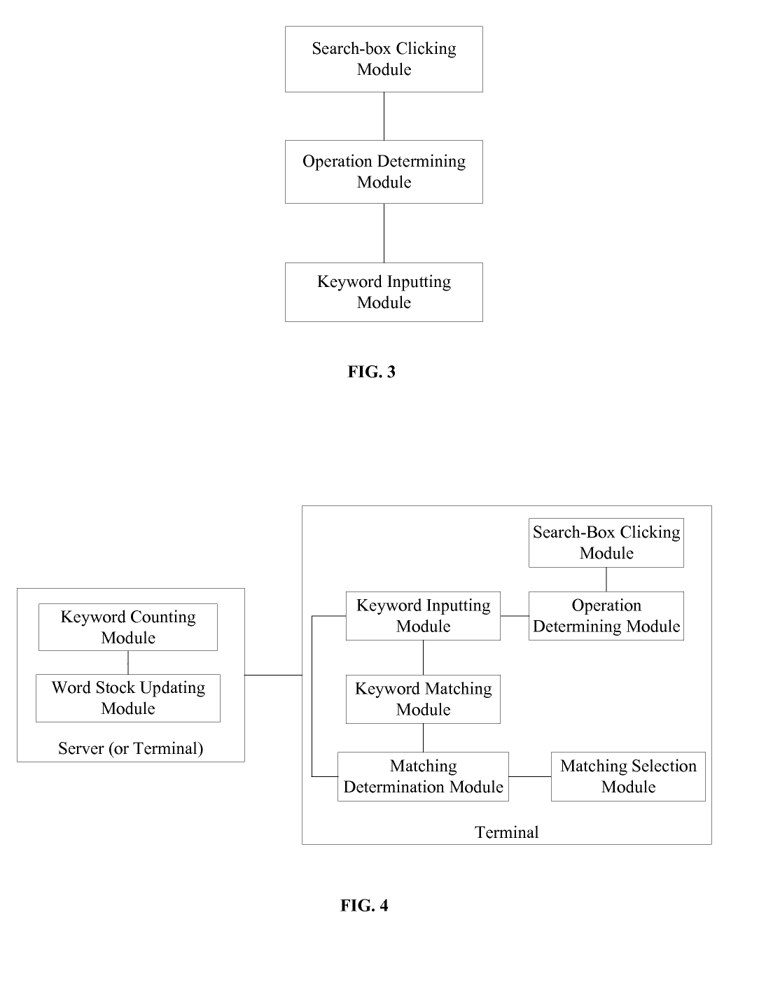

FIG. 4 depicts another exemplary system for searching on a mobile terminal in accordance with various disclosed embodiments. The exemplary system can include a server and/or a mobile terminal. In various embodiments, the exemplary system can be configured in a mobile terminal. The exemplary system can include a keyword counting module, a word stock updating module, a search-box clicking module, an operation determining module, a keyword inputting module, a keyword matching module, a matching determination module, and/or a matching selection module.

The keyword counting module is configured to count real-time dynamic information associated with the keyword, network hot words, and/or a ranking list of keywords that users searched via a mobile terminal. The keyword counting module can also store the counted results in a word stock, e.g., of the mobile terminal.

The word stock updating module is configured to update the word stock according to users' keyword search records and/or changes of the real-time dynamic information. As the search volume increases, keywords searched via mobile terminals increases. The server can update the word stock with more comprehensive and accurate contents/items. Contents of the word stock updated by the server (or the terminal) can be more comprehensive and accurate and maintained up to the latest. In an exemplary embodiment, the word stock can be periodically updated, e.g., having an update cycle of about 2 hours, 8 hours, 12 hours or any hours as desired. The update cycle can be dynamically adjusted according to the user's needs.

The search-box clicking module is configured to click on a search box on a mobile terminal to pop up a smart matching box. The smart matching box can display matching contents including, for example, bookmarks, mostly visited records, search records (e.g., records of a search history), latest hot words, search lists (e.g., a ranking list based on the searched contents), and/or other matching items.

The mostly visited records can include, for example, common activities in daily life. Such common activities can include, e.g., train schedules, air ticket related information, weather conditions, etc. The mostly visited records can be stored locally on a mobile terminal and/or stored on a server.

The latest hot words can include real-time dynamic information (e.g., developments of news and activities) and/or network hot words (e.g., Gaddafi, Turkey earthquake, or “geili”) that are associated with a keyword inputted by a user. The latest hot words can be periodically updated to the local mobile terminal via a server, according to an update cycle of the real-time dynamic information.

The search records and/or the search list can include a ranking list of keywords searched by users through browsers, and counted by the server. The search records and the search list can include contents including, for example, that lean meat powder spreads without restriction in Shandong; Steve Jobs, etc.

Contents in the search records and/or the search list can be stored in word stock(s) after the search list from the search box of the browsers is counted by the server. According to changes of the search list, the word stock(s) can be regularly updated. When the user uses search engines to search by a keyword, contents related to the keyword can be directly matched from the word stock(s) with no need to request the server, each time when the character string changes. This can simplify the inputting operation for the searching and improve a response speed while saving the network traffic.

The operation determining module is configured to determine a user's operation. If the user selects a matching item from the smart matching box, the matching-item search module can search contents of the selected matching item. If the user inputs a keyword in the search box, the keyword can be inputted by the keyword inputting module. In various embodiments, the user can exit the inputting focus from the search box to end current search.

The keyword inputting module is configured to input keyword(s) in the search box via a mobile terminal. The keyword matching module is configured to match the inputted keyword with the matching items in the word stock. The word stock can include, for example, a word stock of commonly used words, a word stock of search lists, and/or a word stock of real-time dynamic information related to the keyword.

The word stock of commonly used words can include, for example, train schedules, air ticket related information, and/or weather, etc. The word stock of search lists can include, for example, that lean meat powder spreads without restriction in Shandong province; Steve Jobs; etc. The word stock of real-time dynamic information related to the keyword can include, for example, Gaddafi, Turkey earthquake, etc.

The word stock of commonly used words can be stored locally on a mobile terminal or on a server. The word stock of search lists and the word stock of real-time dynamic information can be updated, via a server, according to the search lists searched in the search box of browsers by the users, to achieve “known you” (e.g., “you” as a “user”) to predict information for the keyword that the user inputted.

It should be noted that each word stock (e.g., the word stock of commonly used words, the word stock of search lists, and/or the word stock of real-time dynamic information) can include words in any one type of language in the world or in a mixed language form having two or more types of language. Of course, the user may input words on the mobile terminal including words in one certain type of language or including words in two or more different types of language.

For example, a user may enter a word “ [symbol] ” (meaning “fire”) in Chinese, the word “ [symbol] ” in Chinese can be respectively matched in the exemplary word stocks (e.g., the word stock of commonly used words, the word stock of search lists, and/or the word stock of real-time dynamic information). According to a search priority, words such as “ [symbol] ” (meaning “train schedules”, “ [symbol] ” (meaning “Naruto”), “ [symbol] ” (meaning “breaking out of fire”) etc., can be displayed on the smart matching box. In another example, a user may enter a word “ [symbol] ” (meaning “kindnes”) in Chinese. As a result, the smart matching box may display “ [symbol] ” (meaning “German”), “ [symbol] ” (meaning “Debon logistics”), “ [symbol] ” (meaning “Bundesliga”), etc. A user can search according to their search needs to select matching contents/items. This can simplify user's input operation.

One of ordinary skill in the art would appreciate that although words in Chinese are used herein as examples to implement the disclosed methods, other words in different type(s) of language may also be used and encompassed herein. For example, a user may enter a word “table” to be matched in the word stock. As a result, the smart matching box on the mobile terminal may display, for example, “folding table”, “table definition”, “periodic table”, “vegetable”, etc. for the user to select therefrom to obtain desired matching contents/items.

The matching determination module is configured to determine whether there are contents in the word stock matching with the inputted keyword. If there are no contents in the word stock matching with the inputted keyword, the keyword inputting module can continue to input the keyword for searching. If there are contents in the word stock matching with the inputted keyword, the matching selection module can be used to select matching contents.

If the word stock do not include keyword matching contents (i.e., matching contents/items that match with the keyword inputted by the user), the keyword for search can continue to be inputted to search again via the server. Meanwhile, the server can update current search records in the word stocks to provide convenience for the user's next search or for other users to use. In this manner, searching on a mobile terminal can be more quickly and easily. Searching frequency can be improved.

The matching selection module is configured to select the matching contents (from the word stock) displayed on the matching box corresponding to the keyword and to search according to the matching contents.

In an exemplary embodiment, the word stock can be classified to include various matching items. The matching items can include: bookmarks, mostly visited records, latest hot words, search records, search list, etc. In addition, the matching items can be set with various priority levels.

The user can perform the searching by touching a phone screen or by pressing arrow keys to select and click on the matching item. There is no need to again manually inputting words on the phone screen. This can help the users more quickly find the searching results and more conveniently know the real-time dynamic information.

The word stock updating module is configured to according to update the word stock according to the user's keyword search records and the real-time dynamic information. As the search volume increases, keywords searched via the mobile terminals increases. The server can update the word stock with more comprehensive and accurate contents/items. The word stock can be maintained up to date. In an exemplary embodiment, the word stocks can be periodically updated, e.g., having an update cycle of about 2 hours, 8 hours, 12 hours or any hours as desired. The update cycle can be dynamically adjusted according to the user's needs.

In various embodiments, the keyword counting module and the word stock updating module can be configured on a device other than the server, e.g., on a mobile terminal, without limitation. Likewise, the operation determining module, the keyword matching module, the matching determination module, the matching selection module, and/or other modules can be configured on a server or other devices, without being limited to the mobile terminal.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

In the disclosed methods and systems for searching on a mobile terminal, when a search box on a mobile terminal is clicked on, a smart matching box can be automatically popped up. This reduces the time for the user to input a search word (e.g., a keyword), improves the efficiency for inputting, and allows users to quickly search for the desired contents.

The disclosed methods and systems for searching on a mobile terminal can count a ranking list of keywords searched by users through browsers on the mobile terminal. The counted results can be stored in the word stock of the mobile terminal or on the server. The word stock can be updated in a scheduled manner (e.g., regularly or periodically) according to the search records and changes of the real-time dynamic information. When the users use browsers on a mobile terminal to search by a keyword, contents related to the keyword can be directly matched from the word stock(s) with no need to request the network each time when the character string changes. This can simplify the inputting operation for the searching and improve a response speed, while saving the network traffic.

The disclosed methods and systems for searching on a mobile terminal can directly select matching contents from the word stock(s) and use the matching contents as a keyword to perform the searching. There is no need to again manually inputting word(s) on the phone screen. This can help the users more quickly find the searching results and more conveniently know the real-time dynamic information.

The disclosed embodiments can be examples only. One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a storage medium. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for searching on a mobile terminal, comprising:
providing a matching box on the mobile terminal in response to a click on a search box on the mobile terminal;
determining an operation of a user, wherein the operation of the user comprises selecting a matching item from the matching box or inputting a keyword in the search box; and
using the selected matching item as a keyword to search on the mobile terminal when the user selects the matching item from the matching box; or
searching by the inputted keyword in the search box on the mobile terminal.

2. The method of claim 1, wherein the matching item is displayed in the matching box and the matching item comprises bookmarks, mostly visited records, search records, latest hot words, search lists, or combinations thereof.

3. The method of claim 1, wherein searching by the inputted keyword comprises matching the inputted keyword with a word stock.

4. The method of claim 3, wherein matching the inputted keyword with the word stock comprises:
determining whether there is content in the word stock matching with the inputted keyword, and
continuing to input the keyword in the search box, when there is no content in the word stock matching with the inputted keyword.

5. The method of claim 4, wherein, when there is content in the word stock matching with the inputted keyword, the method further comprises:
selecting matching content corresponding to the keyword from the matching box, and
searching according to the matching content.

6. The method of claim 5, wherein, after searching according to the matching content, the method further comprises updating the word stock according to a keyword search record and a change of real-time dynamic information.

7. The method of claim 3, wherein the word stock comprises a word stock of commonly used words, a word stock of search lists, a word stock of real-time dynamic information related to the keyword, or a combination thereof.

8. The method of claim 3, wherein the word stock comprises:
a word stock of commonly used words stored on the mobile terminal; and
a word stock of search lists and a word stock of real-time dynamic information, updated by a ranking list searched in the search box of a browser on the mobile terminal and by a change of the real-time dynamic information.

9. A system for searching on a mobile terminal, comprising:
a search-box clicking module, a keyword inputting module, and an operation determining module, wherein
the search-box clicking module is configured to provide a matching box on the mobile terminal by clicking on a search box on the mobile terminal;
the operation determining module is configured to determine an operation of a user, wherein the operation of the user comprises selecting a matching item from the matching box or inputting a keyword in the search box and wherein the selected matching item is used as a keyword to search on the mobile terminal when the user selects the matching item from the matching box; and
the keyword inputting module is configured for the user to input the keyword in the search box for searching by the inputted keyword.

10. The system of claim 9, wherein the matching item is displayed in the matching box and the matching item comprises bookmarks, mostly visited records, search records, latest hot words, search lists, or combinations thereof.

11. The system of claim 9, further comprising a keyword matching module, a matching selection module, and a matching-item search module.

12. The system of claim 11, wherein:
the keyword matching module is configured to match the inputted keyword with a word stock;
the matching selection module is configured to select matching content corresponding to the keyword and from the matching box; and
the matching-item search module is configured to search according to the matching content.

13. The system of claim 9, further comprising a matching determination module configured to determine whether there is content in the word stock matching with the inputted keyword,
wherein the keyword inputting module is further configured to continue to input the keyword in the search box when there is no content in the word stock matching with the inputted keyword; or
wherein the matching selection module is configured to select corresponding matching content to search when there is content in the word stock matching with the inputted keyword.

14. The system of claim 9, further comprising a keyword counting module and a word stock updating module.

15. The system of claim 9, wherein the keyword counting module is configured to count real-time dynamic information associated with the keyword, network hot words, and a ranking list of keywords that users searched via the mobile terminal; and to store counted results.

16. The system of claims 9, wherein the word stock updating module is configured to update the word stock according to a keyword search record, a change of the real-time dynamic information, or a combination thereof.

17. The system of claim 12, wherein the word stock comprises a word stock of commonly used words, a word stock of search lists, a word stock of real-time dynamic information related to the keyword, or a combination thereof.

18. The system of claim 12, wherein the word stock comprises:
a word stock of commonly used words stored on the mobile terminal; and
a word stock of search lists and a word stock of real-time dynamic information, updated by a ranking list searched in the search box of a browser on the mobile terminal and by a change of the real-time dynamic information.

19. A mobile terminal comprising the system of claim 9.
